(19) United States
(12) Patent Application Publication
(10) Pub. No.: US 2008/0301008 A1
(43) Pub. Date: Dec. 4, 2008

(54) Method and system for vehicle transactions management

(75) Inventors: Joseph DePrisco, Fort Wayne, IN (US); Michael A. Gigli, Fort Wayne, IN (US); Richard L. Raber, Grabill, IN (US); Court Sailor, Spencerville, IN (US)

Correspondence Address: O'MALLEY AND FIRESTONE, 919 SOUTH HARRISON STREET, SUITE 210, FORT WAYNE, IN, 46802, US

(73) Assignee: Northern Apex Corporation

(21) Appl. No.: 11/145,116

(22) Filed: Jun. 3, 2005

Related U.S. Application Data
(60) Provisional application No. 60/578,231, filed on Jun. 9, 2004.

(51) Int. Cl. G06Q 10/00; G08B 13/00

(52) U.S. Cl. 705/28; 340/572.4

(57) ABSTRACT

RFID tags are used to track motor vehicles on and around a vehicle dealer's facility. The information may extend to customer contacts, pending deals and detailed vehicle information. The dealer's salesmen and service writers can access the information using handheld RFID tag readers with which to scan vehicles and integrated PDAs on which data are displayed.

### REFERENCE TO PRIOR PROVISIONAL APPLICATION

This application claims the benefit of U.S. Provisional Application No. 60/578,231, filed 9 Jun. 2004.

### BACKGROUND OF THE INVENTION

1. Technical Field

The present invention relates to radio frequency identification (RFID) tags and incorporation of the tags into a system for managing a automobile dealer's vehicle sales, for vehicle tracking, for keeping service records and for facilitating good customer relations.

2. Description of the Problem

RFID tags are a key element of what has been called ubiquitous computing. RFID tags, particularly passive RFID tags, provide an inexpensive tag which can be: (1) applied to an object; (2) powered from the impinging interrogatory signal, thus requiring no internal power source; and (3) sensed remotely up to several meters distance without the necessity of locating the tag. Each RFID tag carries a permanent, unique identifying numeral, which may be associated with the object to which the tag is attached. The advantages of RFID tags over bar codes and other electronic tagging devices are widely recognized for various asset and inventory management and tracking systems. Generally, the tags have been seen as a way of tracking inventory, particularly as it moves through a distribution system, and adding additional value through electronically readable freshness dates in the case of perishable commodities.

More elaborate RFID tags include writeable, persistent memory and may be considered to be a type of peripheral memory device in a distributed data storage system. The tags are written to and interrogated by a computing system through an associated reader, using a radio frequency interrogation signal. Such an RFID tag incorporates sufficient logic circuitry to write data blocks passed with the interrogation signal to memory and to fetch the contents of blocks of memory. The RFID tag logic usually returns data by load modulation of the radio frequency interrogation signal which originates with the reader or by electromagnetic backscatter at its antenna which is done by varying the reflectance characteristics of the antenna. In either case a modulated return signal is received and read by the computing system. A given RFID tag may be encountered by a computer system once, or a number of times, depending upon the application. Such tags are not however, permanent parts of the computer system, though the tags can function as secondary storage for database records.

RFID tags may be active (battery powered) or passive (deriving energization power from impinging radio frequency signals) devices consisting of an antenna, an AC/DC filter (if passive), a capacitor (if passive), logic and addressable memory. The memory comprises both writable and permanent sections where the permanent section includes an identifier unique to the specific tag. Typically all of the components are bonded onto a acrylic substrate and sealed.

### SUMMARY OF THE INVENTION

According to the invention there is provided a system for the management of a group of vehicles. The vehicles can be part of a dealer's inventory or vehicles which the dealer services. The system comprises at least a first radio frequency identification (RFID) tag attached to a member vehicle of the group. In a preferred embodiment of the invention, a wide area network (WAN) provides a coverage area over an area frequented by member vehicles of the group of vehicles, for example, a new vehicle showroom, a lot and a service area. Alternatively, portable units may be periodically synchronized with a central database through a two way batch update process by connection of the unit to a network docking port. Employees of the dealership are provided with RFID tag readers for interrogating the RFID tags. A portable WAN client or portable computer associated with the RFID tag reader provides for the exchange of data between an employee's handheld device and a central database. The WAN host or portable computer comprises a data processing facility for accessing and updating a database relating to the member vehicles of the group. A database may include time related information as to the location of the vehicle if within the coverage area, vehicle features information and ownership status. The WAN client/portable computer includes a user input/output interface allowing a user to access the database to determine vehicle location, vehicle features and ownership status.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a diagram illustrating coverage area of a wide area network (WAN) into and out of which vehicles move.

FIG. 2 is a high level block diagram of a representative RFID tag;

FIG. 3 is a high level block diagram of a reader for use with the RFID tags of FIG. 2;

FIG. 4 is a high level block diagram of a WAN host data processing system for the reader of FIG. 3;

FIG. 5 is a perspective view of a hand held combination WAN client, RFID reader and user input/output interface;

FIG. 6 is a flow chart of a process executed for collecting vehicle data on initiation of a vehicle to membership in a group;

FIG. 7 is a flow chart of a process executed for assisting a salesman in the process of proposing contracting ownership of a vehicle; and

FIG. 8 is a series of screen shots of prompts provided salesman and vehicle check in operatives.

### DETAILED DESCRIPTION OF THE INVENTION

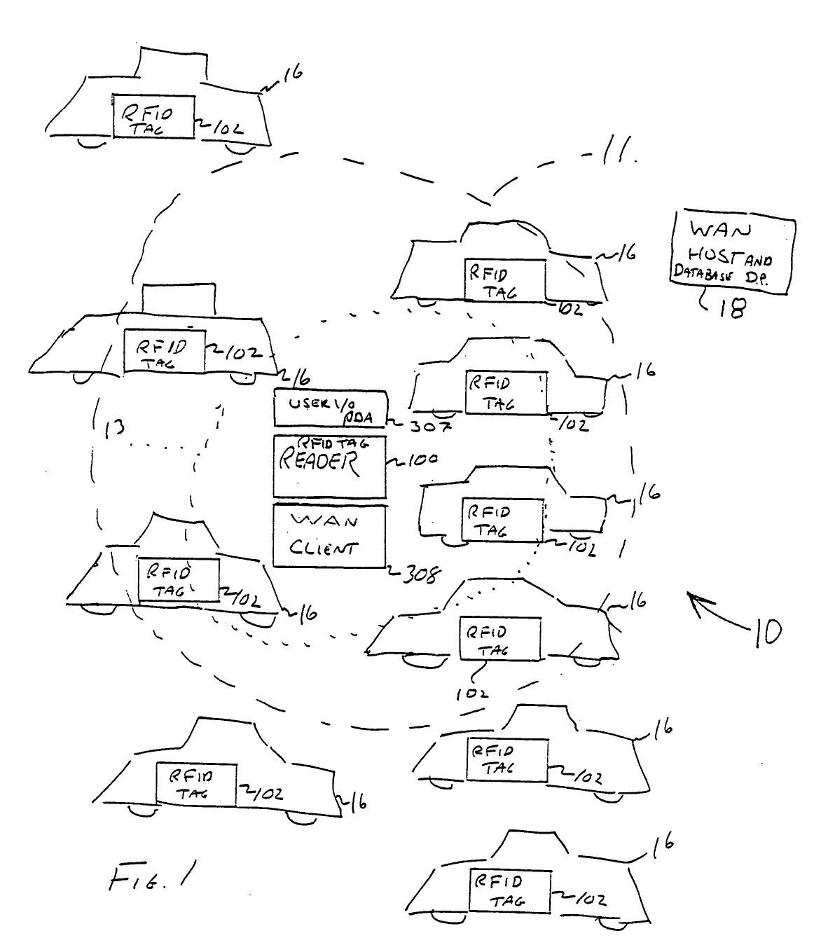

Referring now to the figures and in particular to FIG. 1 there is illustrated a system 10 for motor vehicle data management incorporating RFID tags 102. RFID tags 102 are used for distributed data storage and motor vehicle 16 location tracking. The major components of system 10 include a plurality of related motor vehicles 16, an RFID tag 102 associated with and mounted to each motor vehicle 16 (although depicted as being identical, RFID tags 102 may be of various types), an RFID tag reader or interrogator 100, an associated wide area network (WAN) client 308 for communication with a WAN host and database manager 18, a user I/O unit (typically a personal digital assistant or PDA 307) and the WAN host and database manager 18. Vehicles 16 may move into and out of the coverage area 11 of the wide area network. Although depicted as contiguous, WAN coverage area 11 may be broken into a plurality of segments. Reader 100 is typically used within the coverage area 11 (although this is not strictly necessary for some features of the invention) and has its own coverage area 13. Reader 100 passes into and out of contact with RFID tags 102 mounted on the motor vehicles 16 as vehicles 16 are moved or as the coverage area moves with the moving reader. The WAN coverage area 11 is normally understood to cover a motor vehicle dealer's facility including storage lots/garages, showrooms and maintenance areas. A WAN is only one method, although the preferred one, for practicing the invention. A WAN provides access to real time updated database relating to the motor vehicle group and the associated customer and deal databases. However, batch updating may be used where a WAN is not provided. In addition, although it is preferred that most readers be portable, it is permissible that some be stationary. Stationary readers are advantageously located over service bay entrance and exit doors and other strategic check points on the lot to provide updates on vehicle location. In addition, readers at certain locations can be used to trigger other operations as well as generate near real time vehicle information. For example, a reader over a service bay door may detect entry of a customer's car. If the car is scheduled for service the appropriate work order and customer information may be pushed to a terminal in front of the service writer for use in greeting the customer.

Typically, although not necessarily, RFID tag reader 100 and its associated components are portable and can be moved relative to the plurality of RFID tags 102 installed on vehicles 16. Motor vehicles 16 are movable within, and in and out of coverage area. As a consequence of the portability of the readers 100 and the mobility of the vehicles 16, changing subsets of the RFID tags 102 will fall within a coverage area 13 in which reader 102 can read data stored on the RFID tags 102. Contention access of RFID tags 102 to reader 100 is handled by the reader using techniques already known to the art. Reader 100 which may be simultaneously in communication with an RFID tag 102 and WAN host and database manager (host) 18 may be used as a conduit for information between the host and a given tag and may locally use information derived from either source to effect management functions relating to a member vehicle of the vehicle group. An RFID tag reader 100 thus may be used to report the approximate position of a motor vehicle 16 for incorporation in a database maintained on host 18. If reader 100 is stationary the reported position can simply be the same as that for the reader. Host 18 may be programmed to accept position reports as a matter of course only from stationary readers scattered about a dealers lot and repair facilities. Of course, more complex systems may be imagined incorporating global positioning system monitors associated with readers which could report positions correlated through a look up table with identifiable locations on the lot. The object is to be able to quickly locate a vehicle matching a customer's desires or to locate a customer's vehicle, if returned to the facility for repairs. A vehicle may also be marked as out of the facility if checked out for a test drive. If all data is located on the RFID tags 102, the WAN may be dispensed with.

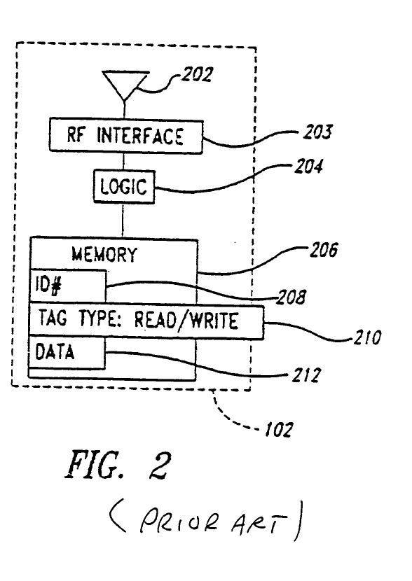

Referring to FIG. 2, a representative RFID data tag 102 provides an input/output interface based on wireless communications, non-volatile memory and addressing logic allowing the memory to be accessed and written to. Power supply circuitry, operating off impinging radio energy is not illustrated for the sake of simplicity. RFID tag 102 includes an antenna 202 and an RF section 203 corresponding to the input/output interface, a logic section 204 providing address generation, and a memory 206. The RF section 203 includes an RF receiver and an RF transmitter or antenna modulator both coupled to the antenna 202. The RF section 203 may include an antenna modulator or RF oscillator depending on the type of RF communications link. Alternatively, the RF receiver and the transmitter can employ separate antennas (not shown). Any of various known types of antennas may be employed, and preferably an antenna matched for the distance, directionality, interference and other requirements of use for the tag.

The logic section 204 includes analog circuits which function as an interface between the RF receiver/transmitter and the digital circuit for reading and writing to the memory 206. The RF receiver portion of the RF section 203 converts an RF signal from the antenna 202 to a DC voltage, which powers RFID tag 102. The digital circuit portion of the logic section 204 generally executes all of the functions of the RFID data tag 102, such as retrieving stored data from the memory 206 and providing a modulating signal to the RF sections to transmit the retrieved data. While the data tag 102 shown is a passive device, a self-powered active device (powered by a battery) can be employed.

Importantly, the memory 206 of the data tag 102 includes at least one of the following fields: a tag ID number field 208, a tag type field 210 and data field 212. The tag ID number field 204 provides a serial number or other identifying number for the data tag 102, which is usually unique to the tag. The data fields 212 may include data stored in the tag 102, such as date, time, and information regarding an object or objects to which the tag may be affixed. Various data related to a motor vehicle 16 will be written to a particular RFID tag 102 upon association of the tag to the vehicle.

Unless described otherwise below, the construction and operation of the various blocks shown in FIG. 2 and the other Figures are of conventional design. As a result, such blocks need not be described in great detail herein, as they will be understood by those skilled in the relevant art. Such description is omitted for purposes of brevity and so as not to obscure understanding of the invention. Any modifications necessary to the blocks of FIG. 2 or the other Figures can be readily made by one skilled in the relevant art based on the detailed description provided herein. The term “field” as used herein can be any select number of byte or bytes or other set of data at a predetermined location in the memory or in a serial string of data, with or without delimiters, headers/trailers or other overhead data to distinguish such bytes from adjacent data. Thus, a field may be recognizable by position, offset, delimiter field identifier or any other method of identifying the appropriate bit, byte or bytes of data within the memory.

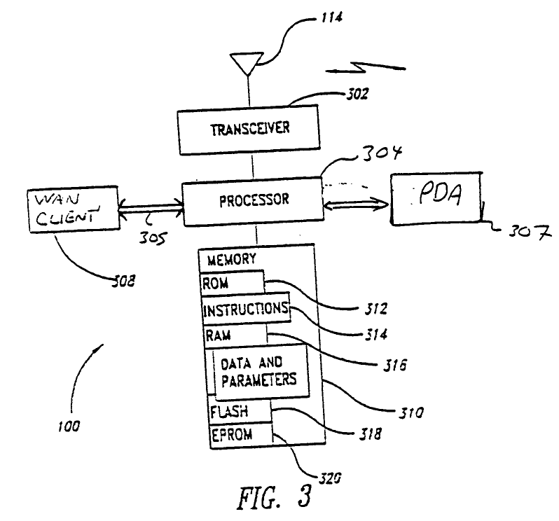

Referring to FIG. 3, a portable reader 100 with associated WAN client 308 (i.e. a communication interface between the reader and a WAN host 18) and I/O interface 307 implemented using a PDA is illustrated. Reader 100 includes an antenna 114 and a transceiver 302 for communicating with the RFID tag 102 and a link 305 to WAN client 308 and PDA 307. Alternatively, PDA 307 and WAN client 308 may communicate directly. While discussed in terms of radio frequency, the reader 100 can operate in other portions of the electromagnetic spectrum, for example, microwave radiation. Typically however, the system is a 900 Mhz system to provide a coverage area 13. A microprocessor or processor 304, coupled to the antenna 114 through the transceiver 302, controls the operation of the reader 100.

Reader 100 includes a memory 310 coupled to the processor 304. The term “processor” as generally used herein refers to any logic processing unit, such as one or more central processing units (CPUs), digital signal processors (DSPs), application-specific integrated circuits (ASIC), etc. While the RF section 203, logic section 204 and memory 206 (for the tags), and processor 304, memory 310 and other components are shown as separate blocks, with some or all of these blocks can be monolithically integrated onto a single chip.

The memory 310 includes random access memory (“RAM”) 316 and read-only memory (“ROM”) 312 to provide storage for instructions, parameters and data for the processor 304. As explained below, the memory 310 includes an instructions memory 314 (RAM or ROM) to allow the processor 304 to be programmed to receive, write, and/or manipulate data in an RFID tag 102. Readers for acquiring data from machine-readable symbols, and for acquiring and writing data to RFID tags, and resolving collisions for access are generally known in the relevant art.

ROM 312 is a non-volatile memory having sufficient space to store at least an operating system kernel. As shown in FIG. 3, the memory 310 also includes flash memory 138 and electronically erasable programmable read-only memory (EEPROM) 320. The ROM 312 may take the form of an “EPROM,” “EEPROM,” or a flash memory to permit the kernel and other instructions to be upgraded. The kernel includes basic input-output instructions and a basic operating system that contains machine-level and system-level commands, functions typically hidden from the user, including device drivers, memory management routines, and system calls. The kernel may be a minimum set of system-level commands required to initiate, or “boot-up,” and control the reader 100.

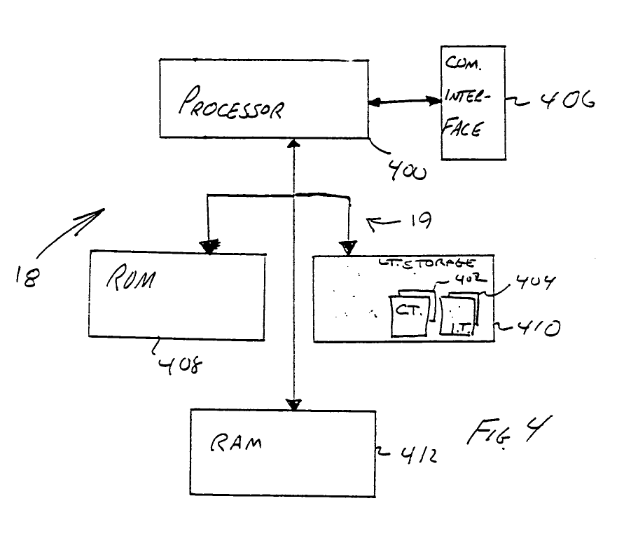

Referring to FIG. 4 a host 18 for system 10 is described. Host 18 is general purpose computer 19 with a WAN communication interface 406. Computer 18 has a conventional memory structure including ROM 408 which includes a computer BIOS, volatile RAM 412 and persistent long term storage 410 which is typically a disk drive. Long term storage provides space for the storage of database tables used in practicing the invention including a customer table (C.T.) 402 and a inventory table (I.T.) 404. The computer 19 has a conventional processor 400 for a CPU.

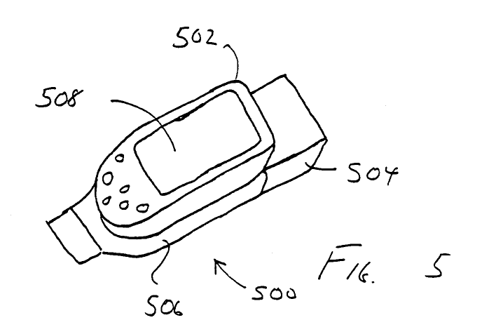

Referring now to FIG. 5 a portable unit 500 for use by a vehicle dealer salesman is illustrated. Portable unit 500 comprises a PDA 502 having a touch sensitive screen 508, a reader 504 and a WAN client 506 integrated as a handheld device. Again, the WAN client is used for realtime updates of the PDA. Should a dealer not have a WAN, the PDA may be periodically attached for hardwire communication with the central database manager and the database segment stored on the PDA and the central database mutually synchronized.

The vehicle management program includes at least 12 modules which are termed: (1) Vehicle Check In; (2) Inventory; (3) Lot security; (4) Sales; (5) Service Bay identification; (6) Loyalty programs; (7) car wash; (8) oil change; (9) body shop; (10) wrecker service; (11) trade-in/appraisal; and (12) asset tracking (part inventory, office furnishings, etc.). To some extent, modules may be separated from one another depending upon the requirements of a particular dealer.

Vehicle Input includes capturing a vehicle VIN for association with an RFID tag applied to a vehicle. Typically a vehicle barcode is scanned to reduce the chance of error associated with manual entry. A series of screens, termed the VIN explosion system, are used to guide the operator to entering all of the data desired for a vehicle. This may include, by way of example, make, model, year, etc., which, for a new car will be entered into an inventory table instance in the database. The RFID tag to be associated with a vehicle is scanned as part of this initiation process to assure accuracy. Once data is acquired linking fields and data are pushed to a standard inventory table and the entry is available for queries.

The sales module is initiated by an operator scanning an RFID tag to construct a database inquiry to obtain vehicle information. A deal initiation icon is generated and the sales process begins with the operator (here a salesman) entering his personal code. Customer fields are generated and filled in, and upon being fully populated, pushed to a customer table forming a record instance.

Loyalty programs, akin to frequent flyer programs, may be incorporated into the system. In one embodiment, customers may be provided with short range, memory writable RFID tags embedded in a key ring fob. The fob may loaded with codes indicating a customer has prepurchased routine service and car washes at reduces prices. Points may be added to the TAG for future discounts or for use at car washes which participate in dealer's program. Salesman may access a customer's information.

Some of the other aspects of the program are more conventional. Lot security for example is analogous to other inventory security programs based on RFID tags. The wrecker module may be made more elaborate. Here the target vehicle may not yet be initiated into the system, as a result, use of the vehicle VIN explosion system may be indicated to the operator. In addition, where a vehicle has been initiated, the operator may take a portable device out of the normal coverage area to scan vehicles for help in locating and verifying the identity of the vehicle to be towed. Screens are provided to indicate locations where vehicles are picked up.

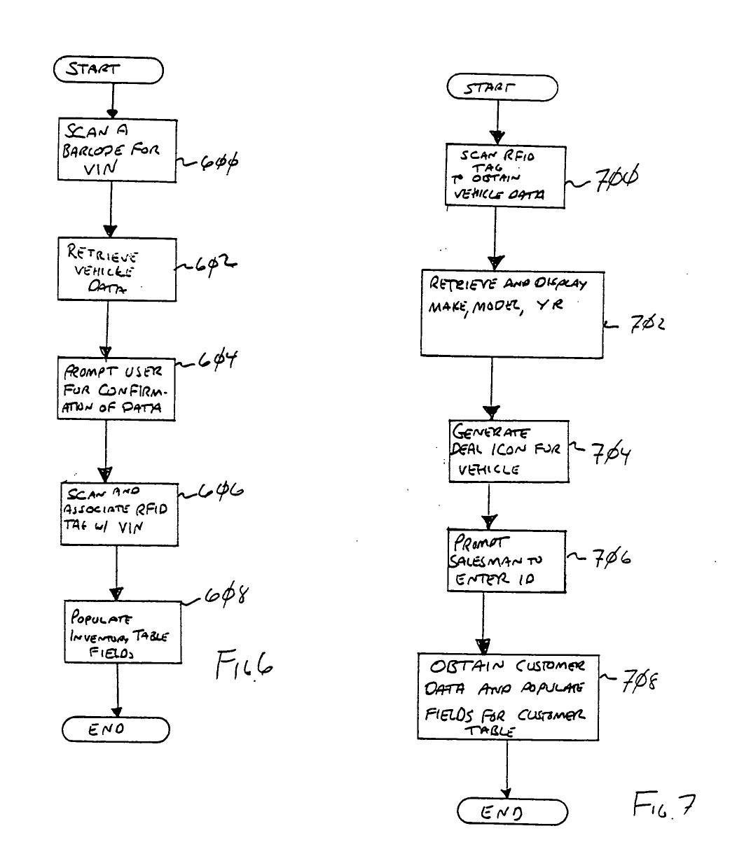

FIG. 6 illustrates the process initiating a motor vehicle into a vehicle group. Upon receipt of a vehicle a bar code scanner, or equivalent device, is used to scan a vehicle bar code to generate a copy of the vehicle identification number (VIN) in system 10 (step 600). It is conceivable that future vehicles will arrive from manufacturers with RFID facilities built into the auto which will include the VIN and that this step of “scanning” will instead involve reading the RFID facility. It is also possible for the VIN to be entered by hand. Next, at step 602, vehicle data is retrieved. A series of screens are displayed on a PDA to assist in this task to assure that all, or at least the essential fields of a database table are populated with the correct data. Step 604 provides for prompting the user to confirm data entries. Next, at step 606 an RFID tag is associated with a vehicle for permanent placement on the vehicle. Data written to the RFID tag will include at a minimum the VIN. Last, at step 608, the inventory table fields for a new vehicle are populated. Copies of the entries for a particular vehicle may be stored both on the host 18 and on an RFID tag 102 for a particular vehicle 16.

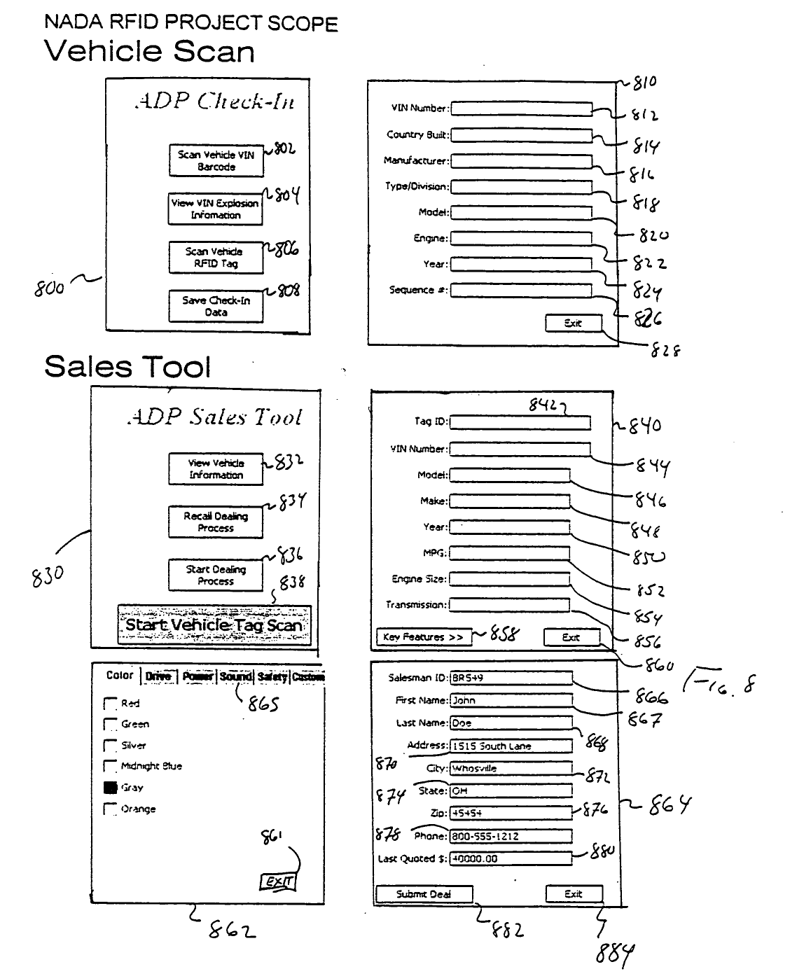

FIG. 7 is a simplified flow chart illustrating operation of system 10 in assisting a salesman or service writer in performing his duties. Step 700 provides for scanning/interrogating an RFID tag to obtain vehicle data. Next, at step 702, data relating to vehicle make, model and model year are retrieved and displayed. Next, step 704 a deal icon for a particular vehicle is generated. Upon selection of the icon, a salesman is prompted to enter his personal identification number (step 706). Step 708 indicates that a series of tables are displayed for the salesman to use prompting obtaining and entering customer data in order to populate the fields for a customer table.

FIG. 8 illustrates various screens, some of which relate to the customer and inventory tables 402 and 404. Screen 800 relates to initiation of a vehicle into a dealer's inventory. Four prompts, some of which, when selected, provide a display context switch to another screen, are illustrated. The first prompt (802) reminds the user to scan the Vehicle VIN barcode. Selection of a second prompt 804 opens screen 810 which displays a series of fields relating to a vehicle to be populated and placed in a database table. The fields are the VIN number (812), the country where the vehicle was built (field 814), the manufacturer of the vehicle (field 816), the vehicle make (type/division field 818), the vehicle model (model field 820), the engine type (field 822), the model year of the vehicle (field 824) and a sequence number field (826). Additional screens may be used to itemize color, sound system package, transmission type (e.g. 4 speed automatic, 5 speed standard, etc.). An exit icon may be used to return context to screen 800. Icon 806 relates to associating a tag 102 to a vehicle, in other words, the data table, or at least the VIN, of screen 810 is written to the tag and also to permanent storage on host 18.

Further referring to FIG. 8, an additional set of screens for display on a PDA are illustrated, this set relating to activities of a salesman. Screen 830 is a base screen which directs the user to screens for viewing vehicle information (icon 832), starting a deal process instance (icon 836) and recalling a deal process instance (icon 834). Another icon 838 provides for interrogating a vehicle RFID tag 102 for vehicle data. A vehicle information screen 840 greatly resembles the VIN explosion information screen 810, adding a few reference lines and changing the order of display slightly. The fields displayed include a Dealer Tag ID field 842, the VIN 844, the vehicle model 846, the make field 848, the model year field 850, the vehicle's fuel economy rating (city/highway) 852, the engine's displacement field 854, and the transmission type 856. Icons also provide for context shifts to screens with additional information, if any (icon 858), and an exit icon 860.

Representative of the “Key Features” accessed by selection of icon 858 is illustrated by screen 862, which opens to a color identification. Tabs 865 across the top of screen 862 allow viewing detailed information about the vehicle's driving features, power features, sound system, safety features and any customization done by the dealer.

Screen 864 is opened upon selection of either the recall or start icons (834 or 836) of screen 830. Here a customer data field table is displayed, which allows entry of new or updated information. This field is recalled from host 18. The fields include the Salesman ID field 866, the customer's first name field 867, a customer last name field 868, a customer street address field 870, a customer resident city field 872, a customer state/province field 874, a customer postal code field 876, a customer phone number field 878, and a last quote field 880. A submit deal field icon 882 provides a commit to memory operation, which may be executed to host 18 or to the vehicle RFID tag 102. An exit icon 884 operates to return the display context to screen 830.

The invention integrates a distributed, database driven vehicle management tool utilizing RFID tags, portable, wireless readers and database management programs operating over a dealer wide WAN. Where no WAN is used, batch updating may be used.

While the invention is shown in only one of its forms, it is not thus limited but is susceptible to various changes and modifications without departing from the spirit and scope of the invention.

What is claimed is:

1. A system for management of transactions relating to a plurality of vehicles, the system comprising:
a database of vehicle related data records;
a plurality of radio frequency identification (RFID) tags where at least on RFID is installed on each of the plurality of vehicles and each of the plurality of RFID tags installed on vehicles has a memory on which is stored a vehicle related data record;
an RFID tag reader responsive to predetermined triggering conditions for interrogating a given RFID tag installed on a vehicle to recover the vehicle related data record stored thereon; and
a data synchronization tool comprising a data processing facility for accessing and updating the database of vehicle related data records and a facility for communicating with the RFID tag reader for obtaining any vehicle related data record recovered by the RFID tag reader.

2. A system for management of transactions relating to a plurality of vehicles as set forth in claim 1, further comprising:
the RFID tag reader also writes to the RFID tags installed on the plurality of vehicles; and
wherein the vehicle related data records in the database and on the RFID tags installed on the plurality of vehicles are time stamped allowing the data synchronization tool to direct update the older of the records.

3. A system for the management of transactions relating to a plurality of vehicles as set forth in claim 2, wherein the facility for communicating with the RFID tag reader is a wide area network having a coverage area corresponding to an automobile dealership facility.

4. A system for the management of transactions relating to a plurality of vehicles as set forth in claim 3, wherein the triggering conditions are proximity of the RFID tag reader to an RFID tag installed on a motor vehicle.

5. A system for the management of transactions relating to a plurality of vehicles as set forth in claim 4, further comprising:
the database of vehicle data records defining a field wherein vehicle location in relation to the automobile dealership facility is indicated and a field wherein ownership status of the vehicle is indicated.

6. A system for the management of transactions relating to a plurality of vehicles as set forth in claim 5, further comprising:
a further database of customer records;
a portable token including an RFID tag to be provided an owner with a vehicle owner record recorded thereon;
a token read/write facility for synchronizing customer records in the database with customer records recorded on the portable tokens; and
a facility for updating data for inclusion in the customer records.

7. A system for the management of transactions relating to a plurality of vehicles as set forth in claim 6, further comprising:
the portable token being embodied in a key chain fob.

8. A system for the management of transactions relating to a plurality of vehicles as set forth in claim 5, further comprising:
portable computing devices;
a database of customer records accessible using the portable computing devices; and
a database of transactions accessible using the portable computing devices relating offers to sell a vehicle to a customer.

9. An automobile dealership management system comprising:
a data processing facility;
a database comprising records relating to the plurality of vehicles maintained on the data processing facility;
a plurality of radio frequency identification (RFID) tags including memory installed at least one to a vehicle in the plurality of vehicles;
at least a partial copy of the database record relating to a particular vehicle stored in the memory of the RFID tag installed on the particular vehicle; and
a communication facility responsive to predetermined triggering conditions for recovering the contents of and writing new contents to the memory of the RFID tag installed on the particular vehicle for the data processing facility.

10. An automobile dealership management system as set forth in claim 9, further comprising:
the data processing facility including a central database server; and
the communication facility including portable RFID tag readers for reading data from and writing data to RFID tags and a wide area network providing a communication link between the RFID tag readers and the data processing facility for the exchange of data read from the RFID tags and data to be written to the RFID tags.

11. An automobile dealership management system as set forth in claim 10, further comprising:
the records and the at least partial copies being time stamped whereby the data processing facility can synchronize records and the at least partial copies.

12. An automobile dealership management system as set forth in claim 11, further comprising:
at least one RFID tag reader having an associated display facility combined in a portable package.

13. An automobile dealership management system as set forth in claim 9, further comprising:
the data processing facility including a central database server; and
the communication facility including portable RFID tag readers for reading data from the RFID tags and a wide area network providing a communication link between the RFID tag readers and the data processing facility for the exchange of data read from the RFID tags and the central database server.

14. An automobile dealership management system as set forth in claim 12, further comprising:
at least one RFID tag reader having an associated display facility combined in a portable package.

15. An automobile dealership management system as set forth in claim 14, further comprising:
a database of individual customer records; and
tokens for distribution to customers, the tokens including RFID tags with memory to which at least partial copies of an individual's customer record is written.

16. A method for managing transactions in an automobile dealership, comprising the steps of:
defining and maintaining a database of vehicle related data records;
installing at least a first radio frequency identification (RFID) tags on each of a plurality of motor vehicles and storing at least a partial copy of the vehicle related data record for each vehicle on the RFID tag for that vehicle;
periodically updating the vehicle related data records;
introducing an RFID tag reader to an area frequented by the vehicles and responsive to predetermined triggering conditions displaying information related to at least a first vehicle on an associated display device to locate the vehicle; and
synchronizing vehicle data records maintained on the database and the at least partial vehicle data records stored on the RFID tags.

17. A method as claimed in claim 16, wherein the RFID tag reader is portable.

18. A method as claimed in claim 17, wherein the RFID tag reader includes an associated display device.

19. A method as claimed in claim 18, further comprising the steps of:
maintaining a customer record database;
supplying tokens with incorporated RFID tags to customers;
writing at least partial copies of a customer's record to the RFID token supplied the customer; and
reading the customer's record from the token upon a customer visit to the automobile dealership and updating the record and at least partial record responsive thereto.
